(19) United States
(12) Patent Application Publication
(10) Pub. No.: US 2016/0372058 A1
(43) Pub. Date: Dec. 22, 2016

(54) Method, Control Device and Control System For Controlling Mirror Display Device

(71) Applicant: BOE TECHNOLOGY GROUP CO., LTD., Beijing (CN)

(72) Inventors: Xiaolin Wang, Beijing (CN); Hui Zhang, Beijing (CN); Jing Lv, Beijing (CN); Yun Sik Im, Beijing (CN)

(21) Appl. No.: 14/770,354

(22) PCT Filed: Oct. 17, 2014
(86) PCT No.: PCT/CN2014/088850

§ 371 Date: Aug. 25, 2015

(30) Foreign Application Priority Data
Jul. 24, 2014 (CN) 201410353926.9

(51) Int. Cl. G09G 3/36; G09G 3/34; G02F 1/1335

(52) U.S. Cl. CPC G09G 3/36; G02F 1/133528; G09G 3/3406; G09G 2360/144; G09G 2320/0626

(57) ABSTRACT

A method, a control device, and a control system for controlling a mirror display device are disclosed. The method for controlling the mirror display device includes: sensing luminance information of a viewing environment; calculating a luminance of a display image and a luminance of a reflection image based on the luminance information; and controlling the luminance of the display image and the luminance of the reflection image in the mirror display device based on the calculated result. The method for controlling the mirror display device enables the luminance of the display image and the luminance of the reflection image in the mirror display device to be changed in accordance with the luminance information of the viewing environment at the same time.

### TECHNICAL FIELD

Embodiments of the present disclosure relate to a method, a control device and a control system for controlling a mirror display device.

### BACKGROUND

A mirror display device is a new type of display devices, which can not only display images but also reflect images.

An ordinary display device comprises a first polarization plate located on a side of an array substrate and a second polarization plate located on a side of a color film substrate. However, a mirror display device further comprises a polarization plate that includes an advanced polarization conversion film (APCF) and that is located between the first polarization plate and the second polarization plate. Lights emitted from a backlight module sequentially pass through the first polarization plate, the polarization plate with the advanced polarization conversion film, and the second polarization plate to achieve display of an image. Lights from the outside environment pass through the second polarization plate and illuminate on the polarization plate with the advanced polarization conversion film. The lights are then reflected by the polarization plate with the advanced polarization conversion film and reemit to the outside environment from the second polarization plate to achieve reflection of an image.

### SUMMARY

According to at least one embodiment of the present disclosure, a method, a control device, and a control system for controlling a mirror display device are provided herein to enable a luminance of a display image and a luminance of a reflection image in the mirror display device to be changed in accordance with luminance information of the viewing environment at the same time.

According to at least one embodiment of the present disclosure, a method for controlling a mirror display device is provided. The method includes: sensing luminance information of a viewing environment; calculating a luminance of a display image and a luminance of a reflection image based on the luminance information; and controlling the luminance of the display image and the luminance of the reflection image in the mirror display device based on the calculated result.

According to at least one embodiment of the present disclosure, a control device for controlling a mirror display device is provided. The control device includes: the mirror display device configured to present a display image and reflect a reflection image; a sensing module configured to sense luminance information of a viewing environment; a calculation module configured to calculate a luminance of the display image and a luminance of the reflection image based on the luminance information; and a control module configured to control the luminance of the display image and the luminance of the reflection image in the mirror display device based on the calculated result from the calculation module.

According to at least one embodiment of the present disclosure, a control system for controlling a mirror display device is provided. The control system includes the mirror display device configured to present a display image and reflect a reflection image. The mirror display device includes a display panel, a first polarization plate, a liquid crystal grating, and a second polarization plate, where the first polarization plate, the liquid crystal grating, and the second polarization plate are sequentially arranged on a side of the display panel. A surface of the first polarization plate near the liquid crystal grating forms a first surface, and the first surface is configured to reflect a light with a polarization direction perpendicular to a direction of a transmission axis of the first polarization plate. The control system further includes: a sensing module configured to sense luminance information of a viewing environment; a calculation module configured to calculate a luminance of the display image and a luminance of the reflection image based on the luminance information; and a control module configured to control the luminance of the display image and the luminance of the reflection image in the mirror display device based on the calculated result.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the invention and thus are not limitative of the invention.

FIG. 1 is a flow chart of a method for controlling a mirror display device according to an embodiment of the present disclosure;

FIG. 2 is a schematic diagram of a control device for controlling the mirror display device according to an embodiment of the present disclosure;

FIG. 3 is a schematic diagram of a control system for controlling the mirror display device according to an embodiment of the present disclosure;

FIG. 4 is a first schematic diagram of a first mirror display device according to an embodiment of the present disclosure;

FIG. 5 is a second schematic diagram of the first mirror display device according to an embodiment of the present disclosure;

FIG. 6 is a first schematic diagram of a second mirror display device according to an embodiment of the present disclosure;

FIG. 7 is a second schematic diagram of the second mirror display device according to an embodiment of the present disclosure;

FIG. 8 is a schematic diagram of a third mirror display device according to an embodiment of the present disclosure;

FIG. 9 is a schematic diagram of a fourth mirror display device according to an embodiment of the present disclosure;

FIG. 10 is a schematic diagram of a fifth mirror display device according to an embodiment of the present disclosure; and

FIG. 11 is a schematic diagram of a sixth mirror display device according to an embodiment of the present disclosure.

Numerical references in the drawings:

| | | |
|---|---|---|
| 1 - sensing module; | 2 - calculation module; | 3 - control module; |
| 4-mirror display | 41-display panel; | 411-third polarization |
| device; | | plate; |
| 412-array substrate; | 413-first liquid crystal | 414-color film |
| | molecular layer; | substrate; |
| 42-first polarization | 43-liquid crystal | 431-first conductive |
| plate; | grating; | layer; |
| 4311-first conductive | 432-second conductive | 4321-second conductive |
| element; | layer; | element; |
| 433- liquid crystal | 44- second polariza- | 45- liquid crystal |
| molecular layer; | tion plate; | grating driving |
| | | structure; |
| 451- first driving | 4511- first driving | 452-second driving |
| member; | unit; | member; |
| 4521- second driving | 46- backlight module. | |
| unit; | | |

### DETAILED DESCRIPTION

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at lease one. The terms “comprises,” “comprising,” “includes,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the present disclosure. Based on the described embodiments herein, those skilled in the art can obtain all of other embodiments, without any inventive work, which should be within the scope of the invention. Inventors of the application found that a luminance of a reflection image is changed when a luminance of an environment observed by the mirror display device is changed. However, a luminance of a display image is unchanged, which causes a mismatch between the luminance of the display image and the luminance of the reflection image in the mirror display device.

### First Embodiment

According to an embodiment of the present disclosure, a method for controlling a mirror display device is provided to enable both a luminance of a display image and a luminance of a reflection image in the mirror display device to change in accordance with luminance information of a viewing environment at the same time.

In an example as shown in FIG. 1, the method for controlling the mirror display device includes the following step S101 to step S103.

Step S101 includes sensing luminance information of a viewing environment. For example, the luminance information may include changes in the luminance of the viewing environment.

Step S102 includes calculating a luminance of a display image and a luminance of a reflection image based on the luminance information.

Step S103 includes controlling the luminance of the display image and the luminance of the reflection image in the mirror display device based on the calculated result.

In one example, in order to achieve an interaction between a display image and a reflection image while the luminance of the display image matches the luminance of the reflection image in the mirror display device, the method for controlling the mirror display device according to an embodiment of the disclosure further includes: first, sensing location information of an object in the viewing environment, for example, the location information including a location change of the object in the viewing environment; then, calculating a change of the display image based on the location information; and finally, controlling the change of the display image in the mirror display device based on the calculated result. In at least one example, controlling the change of the display image in the mirror display device based on the calculated result includes two ways: a first way that includes selecting a corresponding stored display image based on the calculated result to control the change of the display image in the mirror display device; and a second way that includes generating a corresponding display image based on the calculated result to control the change of the display image in the mirror display device.

In at least one example, the luminance information of the viewing environment and the location information of the object in the viewing environment can be sensed at the same time. While the luminance of the display image and the luminance of the reflection image are calculated based on the luminance information, a change of the display image can be calculated based on the location information. The change in the display image, the luminance of the display image and the luminance of the reflection image may be controlled at the same time based on the calculated result.

A mirror display device controlled by the method can be used to develop new interactive games, such as golf games, baseball games, and/or other games. For example, when the mirror display device is used to develop a golf game, the mirror display device can display an image of a golf course. A golf ball is placed at a corresponding location in the golf course depicted in the image. Meanwhile, the mirror display device also reflects one or more objects in the viewing environment. A user can observe the display image and the reflection image at the same time. A superimposition of the display image and the reflection image may form an image of the user in the golf course. When the luminance in the viewing environment changes, the above method for controlling the mirror display device can be used to control the luminance of the display image and the luminance of the reflection image in the mirror display device, so that the luminance of the display image matches the luminance of the reflection image. When the user swings a golf club, an arm or another object, the above method for controlling the mirror display device may be used to control the display image in the mirror display device, so that the display image matches the reflection image. In this case, a superimposition of the display image and the reflection image may form an image that depicts the user swings the golf club to cause the golf ball to roll. As a result, a human-machine interaction is achieved.

According to embodiments of the present disclosure, a method for controlling a mirror display device is provided. The method includes: sensing luminance information of a viewing environment; calculating a luminance of a display image and a luminance of a reflection image based on the luminance information; and controlling the luminance of the display image and the luminance of the reflection image in the mirror display device based on the calculated result. Thus, this method enables the luminance of the display image and the luminance of the reflection image in the mirror display device to change in accordance with the luminance information of the viewing environment at the same time, thereby causing the luminance of the display image to match the luminance of the reflection image. The user's visual experience is therefore improved.

### Second Embodiment

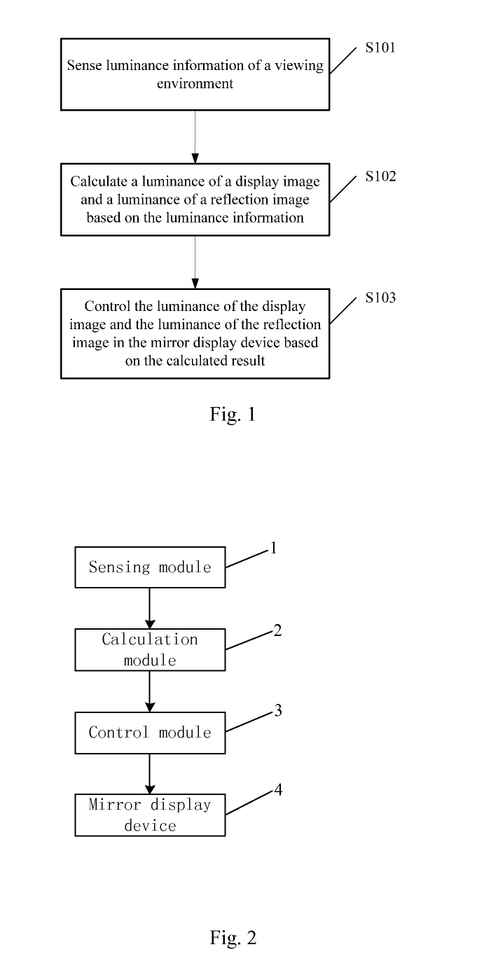

According to an embodiment of the present disclosure, a control device for controlling a mirror display device is provided as shown in FIG. 2. The control device may include a sensing module 1, a calculation module 2, a control module 3 and a mirror display device 4. The sensing module 1 is configured to sense luminance information in a viewing environment. The calculation module 2 is configured to calculate a luminance of a display image and a luminance of a reflection image based on the luminance information. The control module 3 is configured to control the luminance of the display image and the luminance of the reflection image in the mirror display device 4 based on the calculated result from the calculation module 2. The mirror display device 4 is configured to present the display image and reflect the reflection image.

In addition, in order to enable the display image to interact with the reflection image while the luminance of the display image and the luminance of the reflection image are matched, in one example, the sensing module 1 can be further configured to sense location information of an object in the viewing environment. The calculation module 2 can be further configured to calculate a change of the display image based on the sensed location information of the object, and the control module 3 can be further configured to control the change of the display image in the mirror display device 4 based on the calculated result.

In at least one example, the control module 3 may include a display image storage unit or a display image generating unit. If the control module 3 includes the display image storage unit that stores a plurality of display images, the control module 3 selects a corresponding display image from the display image storage unit based on the calculated result to control the change of the display image in the mirror display device 4. If the control module 3 includes the display image generating unit, the display image generating unit generates a corresponding display image based on the calculated result to control the change of the display image in the mirror display device 4.

According to embodiments of the present disclosure, a control device for controlling a mirror display device is provided. The control device may include a sensing module for sensing luminance information of a viewing environment, a calculation module for calculating a luminance of a display image and a luminance of a reflection image based on the luminance information, and a control module for controlling the luminance of the display image and the luminance of the reflection image in the mirror display device based on the calculated result. Thus, this control device enables the luminance of the display image and the luminance of the reflection image in the mirror display device to be changed in accordance with the luminance information of the viewing environment at the same time, so that the luminance of the display image matches the luminance of the reflection image and the user's visual experience is improved.

### Third Embodiment

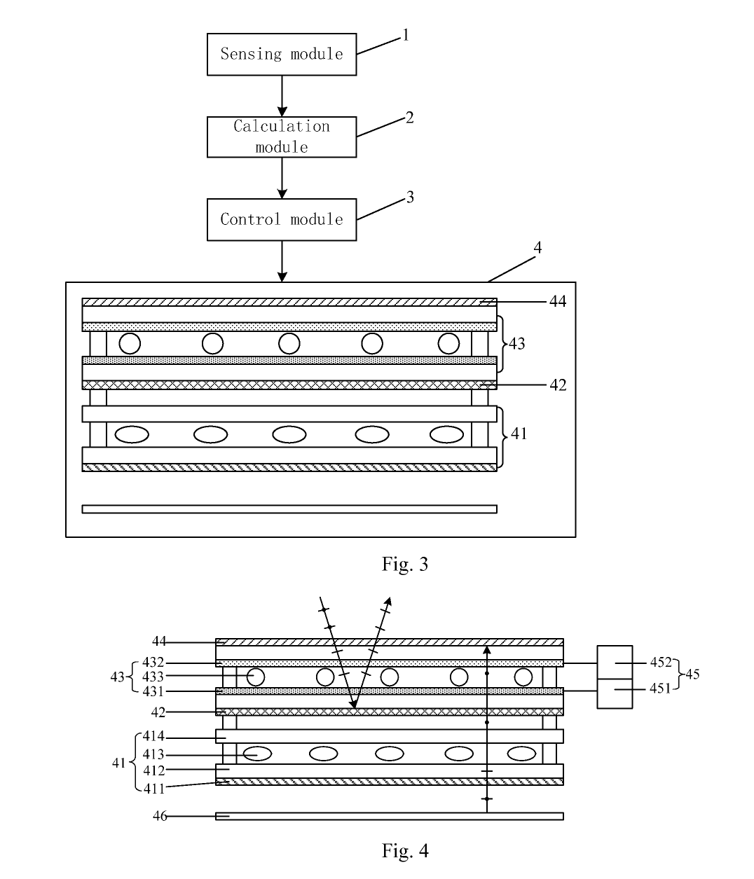

According to embodiments of the present disclosure, a control system for controlling a mirror display device is provided as shown in FIG. 3. The control system may include a sensing module 1, a calculation module 2, a control module 3, and a mirror display device 4. The sensing module 1 is configured to sense luminance information in a viewing environment. For example, the sensing module 1 can include a luminance sensor. The calculation module 2 is configured to calculate a luminance of a display image and a luminance of a reflection image based on the luminance information. The control module 3 is configured to control the luminance of the display image and the luminance of the reflection image in the mirror display device 4 based on the calculated result from the calculation module 2. The mirror display device 4 is configured to present the display image and reflect the reflection image. The mirror display device 4 includes a display panel 41, a first polarization plate 42, a liquid crystal grating 43, and a second polarization plate 44. The first polarization plate 42, the liquid crystal grating 43, and the second polarization plate 44 are sequentially disposed on a side of the display panel 41. A surface of the first polarization plate 42 near the liquid crystal grating 43 may be referred to as a first surface. The first surface may reflect a light with a polarization direction that is perpendicular to a direction of a transmission axis of the first polarization plate 42.

According to embodiments of the present disclosure, a control system for controlling a mirror display device is provided. The mirror display device includes a display panel, a first polarization plate, a liquid crystal grating, and a second polarization plate, where the first polarization plate, the liquid crystal grating, and the second polarization plate are sequentially arranged on a side of the display panel. A surface of the first polarization plate near the liquid crystal grating may form a first surface. The first surface may reflect a light with a polarization direction that is perpendicular to a direction of a transmission axis of the first polarization plate, so that the reflectivity and the transmittivity of the mirror display device is adjustable. Thus, a sensing module may be used to sense luminance information of a viewing environment, a calculation module may be used to calculate a luminance of a display image and a luminance of a reflection image based on the luminance information, and a control module may be used to control the luminance of the display image and the luminance of the reflection image in the mirror display device based on the calculated result. The luminance of the display image and the luminance of the reflection image in the mirror display device may therefore change in accordance with the luminance information of the viewing environment at the same time, so that the luminance of the display image matches the luminance of the reflection image and the user's visual experience is improved.

In addition, in order to achieve interaction between the display image and the reflection image while the luminance of the display image matches the luminance of the reflection image, in one example, the sensing module 1 can be further configured to sense location information of an object in the viewing environment. For example, the sensing module 1 includes a luminance sensor and a location sensor. The calculation module 2 can be further configured to calculate a change of the display image based on the sensed location information of the object, and the control module 3 can be further configured to control the change of the display image in the mirror display device 4 based on the calculated result.

In at least one example, the control module 3 includes a display image storage unit or a display image generating unit. If the control module 3 includes the display image storage unit that stores a plurality of display images, the control module 3 selects a corresponding display image from the display image storage unit based on the calculated result to control the change of the display image in the mirror display device 4. If the control module 3 includes the display image generating unit, the display image generating unit generates a corresponding display image based on the calculated result to control the change of the display image in the mirror display device 4.

In at least one example, the sensing module 1 is communicatively coupled to the calculation module 2 to transmit the sensed luminance information in the viewing environment, the location formation of the object in the viewing environment, and other information to the calculation module 2. The calculation module 2 is communicatively coupled to the control module 3 to transmit the calculated result to the control module 3. The control module 4 is communicatively coupled to the mirror display device 4 to control the change of the display image, the change of the luminance of the display image and/or the change of the luminance of the reflection image in the mirror display device 4.

In order to facilitate understanding of the present disclosure by those skilled in the art, the structure of the mirror display device 4 provided in embodiments of the present disclosure will be described below in details.

In at least one example as shown in FIG. 4, the mirror display device 44 comprises a display panel 41, a first polarization plate 42, a liquid crystal grating 43, and a second polarization plate 44, where the first polarization plate 42, the liquid crystal grating 43, and the second polarization plate 44 are sequentially arranged on a side of the display panel 41. A surface of the first polarization plate 44 that is close to the liquid crystal grating 43 may be referred to as a first surface. The first surface may reflect a light that has a polarization direction perpendicular to a direction of a transmission axis of the first polarization plate 42. Another surface of the first polarization plate 42 that is away from the liquid crystal grating 43 may be referred to as a second surface. For example, the second surface may absorb a light that has a polarization direction perpendicular to the direction of the transmission axis of the first polarization plate 42. The first polarization plate 42 may include a polarization plate with an advanced polarization conversion film (APCF). It is understood that the direction of the transmission axis of the first polarization plate 42 and the direction of the transmission axis of the second polarization plate 44 may be parallel with or perpendicular to each other. Preferably, the direction of the transmission axis of the first polarization plate 42 and the direction of the transmission axis of the second polarization plate 44 are perpendicular to each other in some embodiments of the present disclosure. The control module 3 may control the deflection of the liquid crystal molecules within the liquid crystal grating 43 based on the calculated result from the calculation module 2, thereby achieving the control of the transmittivity and the reflectivity of the mirror display device 4 and the control of the luminance of the display image and the luminance of the reflection image in the mirror display device 4.

In at least one example, the display panel 41 may include a third polarization plate 411, an array substrate 412, a first liquid crystal molecular layer 413, and a color film substrate 414, where the third polarization plate 411, the array substrate 412, the first liquid crystal molecular layer 413, and the color film substrate 414 are arranged in sequence, and the color film substrate 414 is disposed close to the first polarization plate 42.

In at least one example, the liquid crystal grating 43 comprises a first conductive layer 431, a second conductive layer 432, and a liquid crystal molecular layer 433. The control module 3 may control one or more voltages applied to the first conductive layer 431 or the second conductive layer 432 based on the calculated result from the calculation module 2, so as to control the deflections of the liquid crystal molecules within the liquid crystal molecular layer 433. Thus, the control module 3 may control the transmittivity and the reflectivity of the mirror display device 4 and therefore control the luminance of the display image and the luminance of the reflection image in the mirror display device 4. The first conductive layer 431 and the second conductive layer 432 may each be a transparent conductive substrate or a conductive layer formed on a transparent base substrate. For example, the first conductive layer 431 and the second conductive layer 432 may each be a conductive layer formed by a transparent conductive material, such as indium tin oxide (ITO) or indium zinc oxide (IZO), on a transparent base substrate.

In at least one example, the mirror display device 4 may further include a liquid crystal grating driving structure 45 for supplying driving voltages to the first conductive layer 431 and/or the second conductive layer 432. The control module 3 may control the liquid crystal grating driving structure 45 based on the calculated result from the calculation module 2 and thereby control the driving voltages applied to the first conductive layer 431 and/or the second conductive layer 432. The control module 3 may therefore control the deflections of the liquid crystal molecules within the liquid crystal molecular layer 433, so as to control of the transmittivity and the reflectivity in the mirror display device 4. As a result, the control module 3 may control the luminance of the display image and the luminance of the reflection image in the mirror display device 4. For example, the liquid crystal grating driving structure 45 may include a first driving member 451 for supplying one or more driving voltages to the first conductive layer 431 and a second driving member 452 for supplying one or more driving voltages to the second conductive layer 432. It should be understood that the liquid crystal grating driving structure 45 may be an independent structure in some examples, or may be implemented by a gate driving circuit or a source driving circuit integrated with a function for supplying one or more driving voltages to the liquid crystal grating 43.

In at least one example as shown in FIG. 4, the mirror display device 4 may further include a backlight module 46 for supplying light to the display panel 41. In at least one example, a support structure may be provided between the color film substrate 414 and the first polarization plate 42.

In order to facilitate understanding of the present disclosure by those skilled in the art, a display process of the mirror display device 4 provided in embodiments of this disclosure will be described below in details with reference to the accompanying drawings and example application scenarios.

First of all, it is understood that in some embodiments the direction of the transmission axis of the first polarization plate 42 is perpendicular to the direction of the transmission axis of the third polarization plate 411. In some example application scenarios, the direction of the transmission axis of the third polarization plate 411 and the direction of the transmission axis of the second polarization plate 44 may be parallel with or perpendicular to each other. Therefore, depending on the different relationships between the direction of the transmission axis of the third polarization plate 411 and the direction of the transmission axis of the second polarization plate 44, the display process of the mirror display device 4 may be described in two cases (illustratively, embodiments of the present disclosure only provide description for situations where the liquid crystal molecules within the first liquid crystal molecular layer 413 are deflected by 90°).

In a first case, the direction of the transmission axis of the third polarization plate 411 and the direction of the transmission axis of the second polarization plate 44 are parallel with each other. That is, both the direction of the transmission axis of the third polarization plate 411 and the direction of the transmission axis of the second polarization plate 44 are perpendicular to the direction of the transmission axis of the first polarization plate 42.

As shown in FIG. 4, when the liquid crystal molecules within the liquid crystal molecular layer 433 are not deflected, only a part of the lights emitted by the backlight module 46 with a polarization direction that is the same as the direction of the transmission axis of the third polarization plate 411 may pass through the third polarization plate 411. The part of the lights may then pass through the first liquid crystal layer 413, causing the polarization direction of the part of the lights to be changed by 90°. Since the direction of the transmission axis of the first polarization plate 42 and the direction of the transmission axis of the third polarization plate 411 are perpendicular to each other, the part of the lights may pass through the first polarization plate 42 and then arrive at the liquid crystal grating 43. Since the liquid crystal molecules within the liquid crystal molecular layer 433 are not deflected, the polarization direction of the part of the lights may not be changed. Since the direction of the transmission axis of the second polarization plate 44 is perpendicular to the direction of the transmission axis of the first polarization plate 42, the part of the lights may not pass through the second polarization plate 44 (an example propagation mode of the lights in the above process is shown by an arrow on the right side of FIG. 4). Meanwhile, a part of exterior lights from the outside environment with a polarization direction that is the same as the direction of the transmission axis of the second polarization plate 44 may pass through the second polarization plate 44. After passing through the liquid crystal molecular layer 433, the polarization direction of the part of the exterior lights is not changed. Since the direction of the transmission axis of the first polarization plate 42 is perpendicular to the direction of the transmission axis of the second polarization plate 44, the part of the exterior lights is reflected by the first surface when irradiating on the first polarization plate 42. The part of the exterior lights may then pass through the liquid crystal molecular layer 433 and emit from the second polarization plate 44 to the outside environment (an example propagation mode of the lights in the above process is shown by an arrow on the left side of FIG. 4). In this situation, the mirror display device 4 can not display images and can only reflect images.

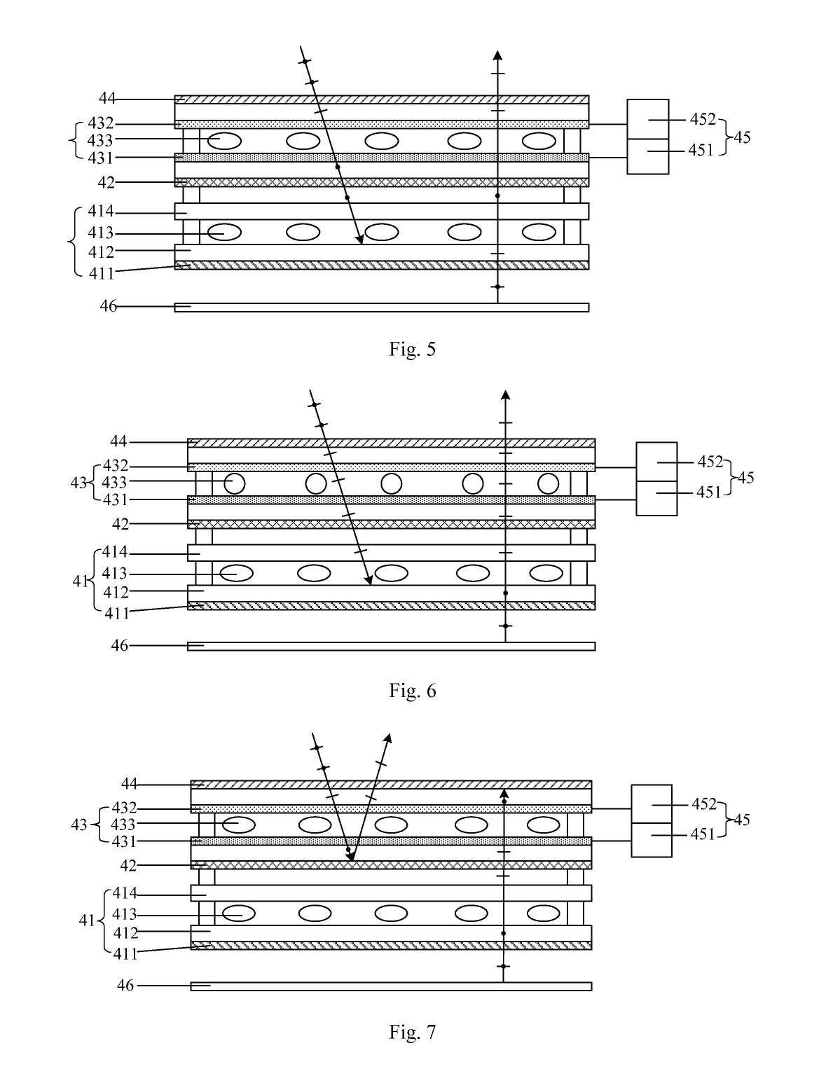

As shown in FIG. 5, when the liquid crystal molecules within the liquid crystal molecular layer 433 are deflected by 90°, only a part of the lights emitted by the backlight module 46 with a polarization direction that is the same as the direction of the transmission axis of the third polarization plate 411 may pass through the third polarization plate 411. The part of the lights may then pass through the first liquid crystal layer 413 and the polarization direction of the part of the lights is changed by 90°. Since the direction of the transmission axis of the first polarization plate 42 and the direction of the transmission axis of the third polarization plate 411 are perpendicular to each other, the part of the lights may pass through the first polarization plate 42 and then arrive at the liquid crystal grating 43. Since the liquid crystal molecules within the liquid crystal molecular layer 433 are deflected by 90°, the polarization direction of the part of the lights is changed by 90° after the part of the lights passes through the liquid crystal molecular layer 433. Since the direction of the transmission axis of the second polarization plate 44 is perpendicular to the direction of the transmission axis of the first polarization plate 42, the part of the lights can pass through the second polarization plate 44 (an example propagation mode of the lights in the above process is shown by an arrow on the right side of FIG. 5). Meanwhile, a part of exterior lights from the outside environment with a polarization direction that is the same as the direction of the transmission axis of the second polarization plate 44 may pass through the second polarization plate 44. The polarization direction of the part of the exterior lights is changed by 90° after passing through the liquid crystal molecular layer 433. Since the direction of the transmission axis of the first polarization plate 42 is perpendicular to the direction of the transmission axis of the second polarization plate 44, the part of the exterior lights may pass through the first polarization plate 42 and then be absorbed by the array substrate 412, the color film substrate 414 and/or other structures (an example propagation mode of the lights in the above process is shown by an arrow on the left side of FIG. 5). In this situation, the mirror display device 4 may only display images and may not reflect any images.

In a second case, the direction of the transmission axis of the third polarization plate 411 and the direction of the transmission axis of the second polarization plate 44 are perpendicular to each other. That is, the direction of the transmission axis of the third polarization plate 411 is perpendicular to the direction of the transmission axis of the first polarization plate 42, and the direction of the transmission axis of the second polarization plate 44 is parallel with the direction of the transmission axis of the first polarization plate 42.

As shown in FIG. 6, when the liquid crystal molecules within the liquid crystal molecular layer 433 are not deflected, only a part of the lights emitted by the backlight module 46 with a polarization direction that is the same as the direction of the transmission axis of the third polarization plate 411 may pass through the third polarization plate 411. The part of the lights may then pass through the first liquid crystal layer 413 and the polarization direction of the part of the lights is changed by 90°. Since the direction of the transmission axis of the first polarization plate 42 and the direction of the transmission axis of the third polarization plate 411 are perpendicular to each other, the part of the lights may pass through the first polarization plate 42 and then arrive at the liquid crystal grating 43. Since the liquid crystal molecules within the liquid crystal molecular layer 433 are not deflected, the polarization direction of the part of the lights is not changed by the liquid crystal molecular layer 433. Since the direction of the transmission axis of the second polarization plate 44 is parallel with the direction of the transmission axis of the first polarization plate 42, the part of the lights may propagate through the second polarization plate 44 (an example propagation mode of the lights in the above process is shown by an arrow on the right side of FIG. 6). Meanwhile, a part of exterior lights from the outside environment with a polarization direction that is the same as the direction of the transmission axis of the second polarization plate 44 may pass through the second polarization plate 44. The polarization direction of the part of the exterior lights is not changed after passing through the liquid crystal molecular layer 433. Since the direction of the transmission axis of the first polarization plate 42 is parallel with the direction of the transmission axis of the second polarization plate 44, the part of the exterior lights may pass through the first polarization plate 42 and may be absorbed by the array substrate 412, the color film substrate 414 and/or other structures (an example propagation mode of the lights in the above process is shown by an arrow on the left side of FIG. 6). In this situation, the mirror display device 4 may only display images and may not reflect any images.

As shown in FIG. 7, when the liquid crystal molecules within the liquid crystal molecular layer 433 are deflected by 90°, only a part of the lights emitted by the backlight module 46 with a polarization direction that is the same as the direction of the transmission axis of the third polarization plate 411 may pass through the third polarization plate 411. The part of the lights may then pass through the first liquid crystal layer 413 and the polarization direction of the part of the lights is changed by 90°. Since the direction of the transmission axis of the first polarization plate 42 and the direction of the transmission axis of the third polarization plate 411 are perpendicular to each other, the part of the lights may pass through the first polarization plate 42 and then arrive at the liquid crystal grating 43. Since the liquid crystal molecules within the liquid crystal molecular layer 433 are deflected by 90°, the polarization direction of the part of the lights is changed by 90° after the part of the lights passes through the liquid crystal molecular layer 433. Since the direction of the transmission axis of the second polarization plate 44 is parallel with the direction of the transmission axis of the first polarization plate 42, the part of the lights cannot propagate through the second polarization plate 44 (an example propagation mode of the lights in the above process is shown by an arrow on the right side of FIG. 7). Meanwhile, a part of exterior lights from the outside environment with a polarization direction that is the same as the direction of the transmission axis of the second polarization plate 44 may pass through the second polarization plate 44. The polarization direction of the part of the exterior lights is changed by 90° after passing through the liquid crystal molecular layer 433. Since the direction of the transmission axis of the first polarization plate 42 is parallel with the direction of the transmission axis of the second polarization plate 44, the part of the exterior lights may not pass through the first polarization plate 42 and may be reflected by the first surface of the first polarization plate 42. After being reflected by the first surface, the part of the exterior lights may pass through the liquid crystal molecular layer 433, causing the polarization direction to be changed by 90° again. As a result, the part of the exterior lights may emit from the second polarization plate 44 to the outside environment (an example propagation mode of the lights in the above process is shown by an arrow on the left side of FIG. 7). In this situation, the mirror display device 4 may only reflect an image and may not display any image.

It should be understood that only two scenarios are described above, including a first scenario where the liquid crystal molecules within the liquid crystal molecular layer 433 are not deflected and a second scenario where all the liquid crystal molecules within the liquid crystal molecular layer 433 are deflected by 90°. Those skilled in the art would understand that, due to different voltages being applied to the first conductive layer 431 and the second conductive layer 432, the liquid crystal molecules within the liquid crystal molecular layer 433 may be deflected by a degree which is larger than 0° and less than 90°. In this case, the mirror display device 4 can not only present the display image, but also reflect the reflection image. In this case, the transmittivity and the reflectivity of the mirror display device 4 are related to various factors such as the reflectivity of the first polarization plate 42, the transmittivity of the second polarization plate 44, the transmittivity of the third polarization plate 411, and the transmittivity of the liquid crystal grating 43. The transmittivity of the liquid crystal grating 43 is related to a distance between the first conductive layer 431 and the second conductive layer 432 and driving voltages applied to the first conductive layer 431 and the second conductive layer 432. Thus, the transmittivity and the reflectivity of the mirror display device 4 can be adjusted by changing the driving voltages applied to the first conductive layer 431 and the second conductive layer 432.

In order to achieve a better display result, an example implementation of the mirror display device 4 is provided in some embodiments of the present disclosure. The example implementation includes configuring the mirror display device 4 to include first areas that only display images and second areas that only reflect images so that a partial mirror display is achieved.

For example, multiple configurations as described below may be implemented to achieve a partial mirror display according to some embodiments of the present disclosure.

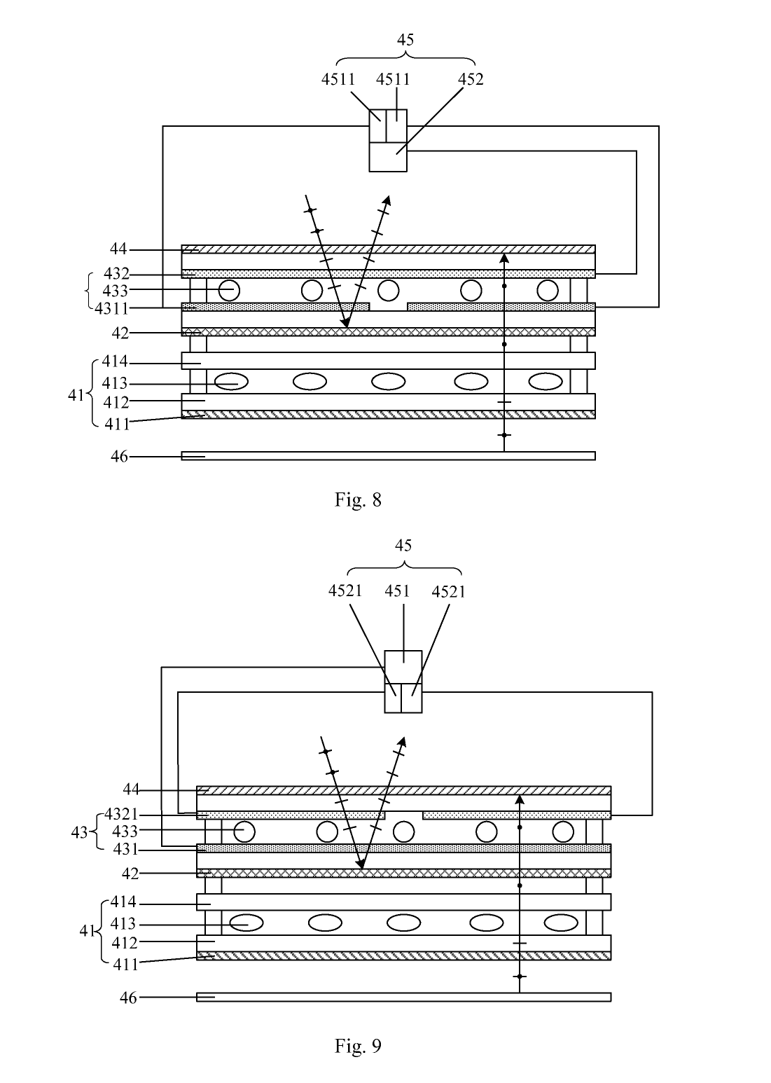

In a first configuration as shown in FIG. 8, the first conductive layer 431 may include a plurality of first conductive elements 4311 that are independent from each other. The first driving member 451 includes first driving units 4511 that have a one-to-one correspondence with the first conductive elements 4311. Each of the first driving units 4511 supplies a driving voltage to a respective first conductive element 4311. If different first driving units 4511 supply different driving voltages to respective first conductive elements 4311, degrees of deflections of the liquid crystal molecules within the liquid crystal molecular layer 433 are different in areas where the different first conductive elements 4311 are located. As a result, control effects of the lights in the different areas are different. For example, the first conductive layer 431 may include two independent first conductivity elements 4311, and the liquid crystal grating driving structure 45 includes two first driving units 4511. When only one of the first driving units 4511 supplies a driving voltage to a corresponding first conductive element 4311, the liquid crystal molecules within an area where the corresponding first conductive element 4311 is located are deflected while the liquid crystal molecules within other areas are not deflected. In this case, if the area where the corresponding first conductive element 4311 is located displays a display image, the other areas may reflect a reflection image; and if the area where the corresponding first conductive element 4311 is located reflects a reflection image, the other areas may display a display image. As a result, a partial mirror display may be achieved.

In a second configuration as shown in FIG. 9, the second conductive layer 432 includes a plurality of second conductive elements 4321 that are independent from each other. The second driving member 452 includes second driving units 4521 that have a one-to-one correspondence with the second conductive elements 4321. Each of the second driving units 4521 supplies a driving voltage to a respective second conductive element 4321. If the second driving units 4521 supply different driving voltages to respective second conductive elements 4321, degrees of deflections of the liquid crystal molecules within the liquid crystal molecular layer 433 are different in areas where the second conductive elements 4321 are located. As a result, control effects of the lights in the different areas are different. For example, the second conductive layer 432 may include two independent second conductive elements 4321, and the liquid crystal grating driving structure 45 includes two second driving unit 4521. When only one of the second driving unit 4521 supplies a driving voltage to a corresponding second conductive element 4321, the liquid crystal molecules within an area where the corresponding second conductive element 4321 is located are deflected and the liquid crystal molecules within other areas are not deflected. In this case, if the area where the corresponding second conductive element 4321 is located displays a display image, the other areas may reflect a reflection image; and if the area where the corresponding second conductive element 4321 is located reflects a reflection image, the other areas may display a display image. As a result, a partial mirror display may be achieved.

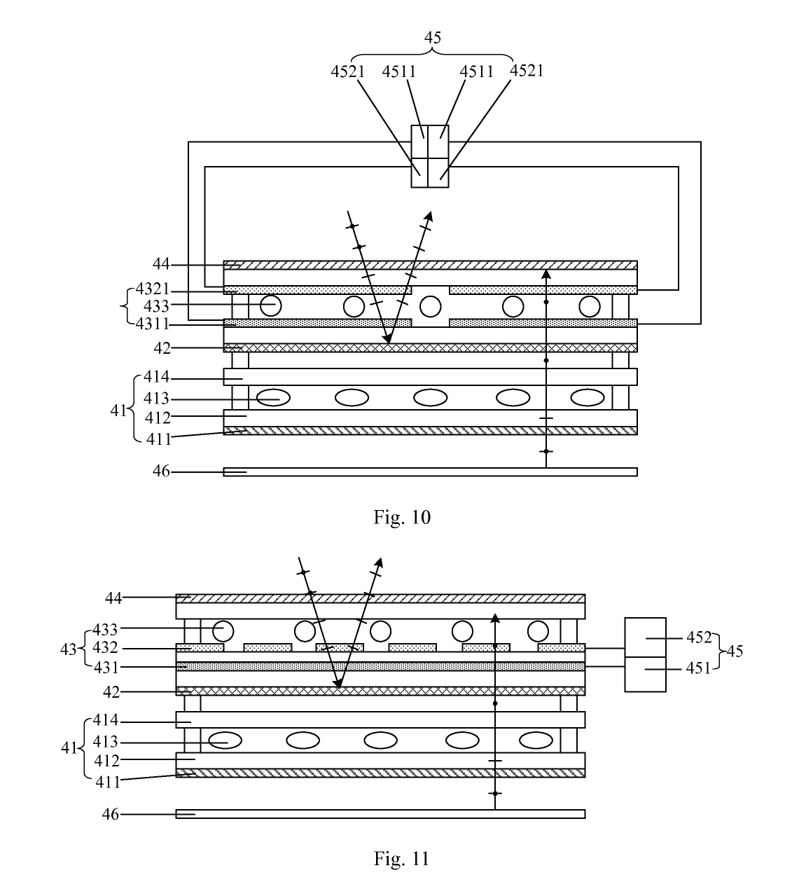

In a third configuration as shown in FIG. 10, the first conductive layer 431 may include a plurality of first conductive elements 4311 that are independent from each other. The second conductive layer 432 includes a plurality of second conductive elements 4321 that are independent from each other. The first driving member 451 includes first driving units 4511 that have a one-to-one correspondence with the first conductive elements 4311. The second driving member 452 includes second driving units 4521 that have a one-to-one correspondence with the second conductive elements 4321. Each of the first driving units 4511 supplies a driving voltage to a respective first conductive element 4311, and each of the second driving units 4521 supplies a driving voltage to a respective second conductive element 4321. Degrees of deflections of the liquid crystal molecules within the liquid crystal molecular layer 433 in a particular area are determined by a synthesized driving voltage in the particular area. The synthesized driving voltage is the sum of a first driving voltage applied to a corresponding first conductive element 4311 in the particular area and a second driving voltage applied to a corresponding second conductive element 4321 in the particular area. By adjusting the liquid crystal grating driving structure 45, synthesized driving voltages that correspond to liquid crystal molecules within different areas may be different, thereby achieving a partial mirror display. A quantity of the first conductive elements 4311 and a quantity of the second conductive elements 4321 may be the same or different. A projection of the first conductive elements 4311 and a projection of the second conductive elements 4321 may be completely overlapped, partially overlapped, or completely non-overlapped. Preferably, in some embodiments of this disclosure the quantity of the first conductive elements 4311 and the quantity of the second conductive elements 4321 are the same, and the projection of the first conductive elements 4511 and the projection of the second conductive elements 4521 are completely overlapped.

In some examples, for any one of the three configurations described above, for example the first configuration, when pixels of odd-numbered columns of the mirror display device 4 display a left-eye image, pixels of even-numbered columns display a right-eye image, and the first conductive layer 431 includes a plurality of first conductive elements 4311, driving voltages applied to the different first conductive element 4311 may be controlled to cause translucent regions and opaque regions in the mirror display device 4 to be alternately arranged. Thus, the left eye of an observer can only observe a left-eye image and the right eye of the observer can only observe a right-eye image, so that the mirror display device 4 achieves a naked-eye three-dimensional (3D) display effect. In this case, transmittivity and reflectivity of each area where a corresponding first conductive element 4311 is located can not be adjusted. However, the transmittivity and the reflectivity of the mirror display device 4 can be adjusted by changing a ratio between an area of the translucent regions and an area of the opaque regions in the mirror display device 4.

It is understood that the several configurations described above only represent multiple possible implementations. Based on the embodiments described herein, those skilled in the art can obtain other embodiment(s) without any inventive work, which are not described herein.

Because the deflections of the liquid crystal molecules may be driven by a horizontal electric field, a vertical electric field, or a multi-dimensional electric field, no limitation is placed on a relative location between the first conductive layer 431 and the second conductive layer 432 as well as on shapes of the first conductive layer 431 and the second conductive layer 432, with regard to the liquid crystal grating 43 in the embodiments of this disclosure. For example, as shown in FIGS. 4-10, the first conductive layer 431 and the second conductive layer 432 may be relatively arranged on two sides of the liquid crystal molecular layer 433, and the first conductive layer 431 and the second conductive layer 432 may each be a plate. For example, as shown in FIG. 11, the first conductive layer 431 and the second conductive layer 432 may be located on a side of the liquid crystal molecular layer 433, an insulating layer may be disposed between the first conductive layer 431 and the second conductive layer 432, and slits may be configured on the first conductive layer 431 and/or the second conductive layer 432.

What are described above is related to the illustrative embodiments of the disclosure only and not limitative to the scope of the disclosure. Those skilled in the art may easily think of any alteration or replacement within the technical field described herein, which are also within the scope of the disclosure. The scopes of the disclosure are defined by the accompanying claims.

This application claims a priority of Chinese patent application No. 201410353926.9 filed on Jul. 24, 2014, the disclosure of which is incorporated herein by reference in its entirety.

1. A method for controlling a mirror display device, the method comprising:
sensing luminance information of a viewing environment;
calculating a luminance of a display image and a luminance of a reflection image based on the luminance information; and
controlling the luminance of the display image and the luminance of the reflection image in the mirror display device based on the calculated result.

2. The method for controlling the mirror display device of claim 1, further comprising:
sensing location information of an object in the viewing environment;
calculating a change of the display image based on the sensed location information; and
controlling the change of the display image in the mirror display device based on the calculated result.

3. The method for controlling the mirror display device of claim 2, further comprising:
selecting a corresponding display image from stored display images based on the calculated result to control the change of the display image in the mirror display device.

4. The method for controlling the mirror display device of claim 2, further comprising:
generating a corresponding display image based on the calculated result to control the change of the display image in the mirror display device.

5. A control device for controlling a mirror display device, the control device comprising:
the mirror display device configured to present a display image and reflect a reflection image;
a sensing module configured to sense luminance information of a viewing environment;
a calculation module configured to calculate a luminance of the display image and a luminance of the reflection image based on the luminance information; and
a control module configured to control the luminance of the display image and the luminance of the reflection image in the mirror display device based on the calculated result from the calculation module.

6. The control device for controlling the mirror display device of claim 5, wherein:
the sensing module is further configured to sense location information of an object in the viewing environment;
the calculation module is further configured to calculate a change of the display image based on the location information; and
the control module is further configured to control the change of the display image in the mirror display device based on the calculated result from the calculation module.

7. The control device for controlling the mirror display device of claim 6, wherein:
the control module comprises a display image storage unit that stores a plurality of display images; and
the control module is configured to select a corresponding display image from the display image storage unit based on the calculated result to control the change of the display image in the mirror display device.

8. The control device for controlling the mirror display device of claim 6, wherein:
the control module comprises a display image generating unit, the display image generating unit configured to generate a corresponding display image based on the calculated result to control the change of the display image in the mirror display device.

9. A control system for controlling a mirror display device, the control system comprising:
the mirror display device configured to present a display image and reflect a reflection image, wherein:
the mirror display device includes a display panel, a first polarization plate, a liquid crystal grating, and a second polarization plate;
the first polarization plate, the liquid crystal grating, and the second polarization plate are sequentially arranged on a side of the display panel;
a surface of the first polarization plate near the liquid crystal grating forms a first surface; and
the first surface is configured to reflect a light with a polarization direction that is perpendicular to a direction of a transmission axis of the first polarization plate;
a sensing module configured to sense luminance information of a viewing environment;
a calculation module configured to calculate a luminance of a display image and a luminance of a reflection image based on the luminance information; and
a control module configured to control the luminance of the display image and the luminance of the reflection image in the mirror display device based on the calculated result.

10. The control system for controlling the mirror display device of claim 9, wherein:
the sensing module is further configured to sense location information of an object in the viewing environment;
the calculation module is further configured to calculate a change of the display image based on the location information; and
the control module is further configured to control the change of the display image in the mirror display device based on the calculated result from the calculation module.

11. The control system for controlling the mirror display device of claim 10, wherein:
the control module comprises a display image storage unit that stores a plurality of display images; and
the control module is configured to select a corresponding display image from the display image storage unit based on the calculated result to control the change of the display image in the mirror display device.

12. The control system for controlling the mirror display device of claim 10, wherein:
the control module comprises a display image generating unit, the display image generating unit configured to generate a corresponding display image based on the calculated result to control the change of the display image in the mirror display device.

13. The control system for controlling the mirror display device of claim 9, wherein the sensing module comprises a luminance sensor.

14. The control system for controlling the mirror display device of claim 10, wherein the sensing module comprises a luminance sensor and a location sensor.

15. The control system for controlling the mirror display device of claim 9, wherein the sensing module is communicatively coupled to the calculation module, the calculation module is communicatively coupled to the control module, and the control module is communicatively coupled to the mirror display device.

16. The control system for controlling the mirror display device of claim 9, wherein:
another surface of the first polarization plate that is away form the liquid crystal grating forms a second surface; and
the second surface is configured to absorb a second light with a polarization direction that is perpendicular to the direction of the transmission axis of the first polarization plate.

17. The control system for controlling the mirror display device of claim 9, wherein:
the liquid crystal grating comprises a first conductive layer, a second conductive layer, and a liquid crystal molecular layer; and
the control module controls a voltage applied on the first conductive layer or the second conductive layer based on the calculated result from the calculation module to control deflection of liquid crystal molecules in the liquid crystal molecular layer.

18. The control system for controlling the mirror display device of claim 17, wherein:
the mirror display device further comprises a liquid crystal grating driving structure, the liquid crystal grating driving structure configured to supply one or more driving voltages to one or more of the first conductive layer and the second conductive layer; and
the control module controls the liquid crystal grating driving structure based on the calculated result from the calculation module to control the one or more driving voltages applied on the one or more of the first conductive layer and the second conductive layer.

19. The control system for controlling the mirror display device of claim 18, wherein:
the liquid crystal grating driving structure includes a first driving member for supplying a first driving voltage to the first conductive layer and a second driving member for supplying a second driving voltage to the second conductive layer.

20. The control system for controlling the mirror display device of claim 19, wherein:
the first conductive layer comprises a plurality of first conductive elements that are independent from each other, the first driving member includes first driving units that have a one-to-one correspondence with the first conductive elements, and each of the first driving units is configured to supply a corresponding driving voltage to a corresponding first conductive element; and/or
the second conductive layer comprises a plurality of second conductive elements that are independent from each other, the second driving member includes second driving units that have a one-to-one correspondence with the second conductive elements, and each of the second driving units is configured to supply a corresponding driving voltage to a corresponding second conductive element.
